(19) United States
(12) Patent Application Publication
(10) Pub. No.: US 2009/0159631 A1
(43) Pub. Date: Jun. 25, 2009

(54) TENSION CONTROL FOR A SHEET MATERIAL FEEDER

(75) Inventors: Arthur H. DePoi, Brookfield, CT (US); Boris Rozenfeld, New Milford, CT (US); Anthony E. Yap, Southington, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 11/963,902

(22) Filed: Dec. 24, 2007

(51) Int. Cl. B65H 23/14; B65H 7/00; B65H 7/02; B26D 7/06

(52) U.S. Cl. 226/8; 271/256; 271/258.01; 83/109

(57) ABSTRACT

A sheet material feeder includes a sheet material web, a vacuum box applying a tension force to a portion of the sheet material web extending into the vacuum box by applying a first vacuum force on the sheet material web, a first drive feeding the sheet material web into the vacuum box, a second drive pulling the sheet material web out of the vacuum box, and a system for applying a braking force to the sheet material web proximate to the vacuum box only during a decelerating movement of the sheet material web at the second drive.

### FIELD OF THE INVENTION

The invention relates to a sheet material feeder and, more particularly, to maintaining tension of a sheet material web in a sheet material feeder.

### BACKGROUND OF THE INVENTION

Web tension is an important factor in providing an accurate sheet length cut in a high speed web cutter. In order to handle the web properly, the web must be under tension. Maintaining a web under tension in the cutter becomes even more challenging due to the rapid start/stop motion of the web. During rapid deceleration, inertia loading on the web is significantly larger than the tension force provided by devices commonly used as a tensioning device in a high speed pinfeed cutter, such as a vacuum box, for example. Attempts to solve the web tensioning problem by simply increasing the vacuum level in the vacuum box have been unsuccessful because increased web tension during web acceleration causes the web to break.

There is a desire to provide a sheet material feeder that can maintain the web tension of a sheet material web during rapid deceleration of the web without causing the web to break during web acceleration. This may be of particular interest in a high speed apparatus having a sheet material cutter that requires the sheet material web to be stopped for cutting.

### SUMMARY OF THE INVENTION

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In one aspect, the invention relates to a sheet material feeder comprising a sheet material web, a vacuum box applying a tension force to a portion of the sheet material web extending into the vacuum box by applying a first vacuum force on the sheet material web, a first drive feeding the sheet material web into the vacuum box, a second drive pulling the sheet material web out of the vacuum box, and a system for applying a braking force to the sheet material web proximate to the vacuum box only during a decelerating movement of the sheet material web at the second drive.

In another aspect, the invention relates to a method of maintaining web tension in a sheet material feeder comprising feeding a sheet material web from a first drive, through a vacuum box, to a second drive, and applying a braking force to the sheet material web proximate to the vacuum box only during a decelerating movement of the sheet material web at the second drive, wherein the braking force supplements a vacuum force applied to the sheet material web in the vacuum box to maintain a web tension of the sheet material web between the vacuum box and the second drive.

In yet another aspect, the invention relates to a method of maintaining web tension in a sheet material feeder comprising feeding a sheet material web from a first drive, through a vacuum box, to a second drive, applying a force to the sheet material web proximate to the vacuum box only during a decelerating movement of the sheet material web at the second drive to thereby form a frictional brake to maintain a web tension of the sheet material web between the vacuum box and the second drive, and adjusting the force based on a coefficient of friction of the sheet material web to provide a substantially uniform friction force for sheet material webs comprising different compositions of materials.

In accordance with another aspect of the invention, a sheet material feeder is provided comprising a vacuum box adapted to apply a vacuum force to a sheet material web extending into the vacuum box; and a system for applying a friction force to the sheet material web proximate an exit from the vacuum box. The system for applying the friction force is adjustable to allow a substantially same friction force value to be applied to different compositions of the sheet material webs having different coefficients of friction.

In accordance with another aspect of the invention, a method of maintaining web tension in a sheet material feeder is provided comprising feeding a sheet material web from a first drive, through a vacuum box, to a second drive; and applying a brake force to the sheet material web proximate the vacuum box during a decelerating movement of the sheet material web at the second drive. The brake force supplements a vacuum force applied to the sheet material web in the vacuum box to help maintain the web tension of the sheet material web between the vacuum box and the second drive.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The foregoing aspects and other features of the invention are explained in the following description, taken in connection with the accompanying drawings, wherein:

FIG. 1 is a schematic diagram of an apparatus comprising features of the invention;

FIG. 2 is a perspective view of the feeder shown in FIG. 1;

FIG. 3 is a side view of the feeder shown in FIG. 2;

FIG. 4 is a cross sectional view of the vacuum box shown in FIG. 3 taken along line 4-4;

FIG. 4A is a perspective view of the web on the exit curved deck section from the vacuum box;

FIG. 5 is a block diagram of components of the feeder shown in FIGS. 1-4;

FIG. 6 is a block diagram of components of the brake shown in FIGS. 3 and 5;

FIG. 7 is a block diagram of control components of the invention shown in FIGS. 1-6;

FIG. 8 is a flow chart of steps of one embodiment of a method according to the invention; and

FIG. 9 is a partial side view of an alternative embodiment of the invention.

### DETAILED DESCRIPTION OF EXEMPLARY EMBODIMENTS

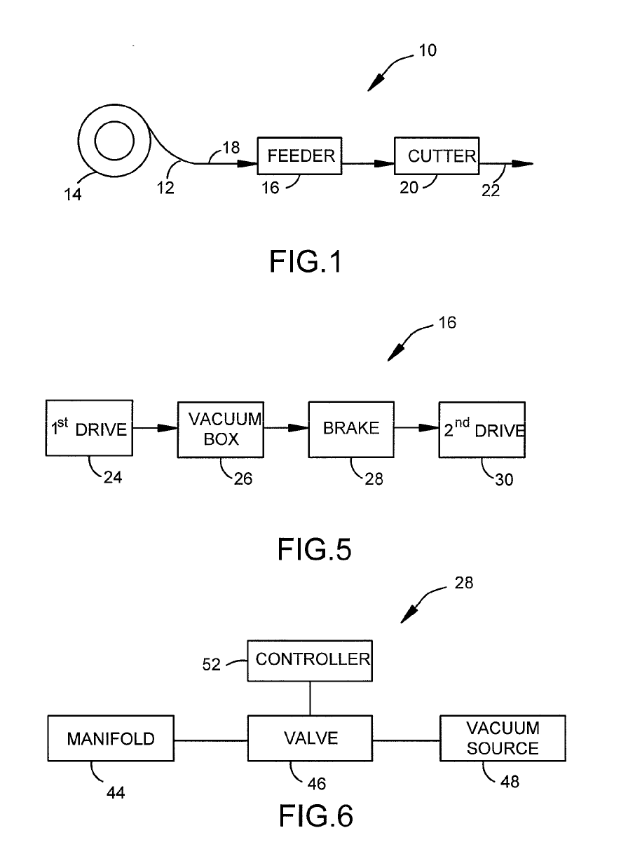

Referring to FIG. 1, there is shown a schematic diagram of an apparatus 10 incorporating features of the invention. Although the invention will be described with reference to the exemplary embodiments shown in the drawings, it should be understood that the invention can be embodied in many alternate forms of embodiments. In addition, any suitable size, shape, or type of elements or materials could be used.

The apparatus 10 is a continuous web cutting apparatus. Typically, a continuous web cutting apparatus is used to cut a continuous sheet material web into cut sheets and to provide the sheets to an accumulator. The accumulator takes the sheets and moves them to an insertion station in a mass mailing inserting system. In the embodiment shown in FIG. 1, the sheet material 12 is provided as a roll 14. However, in an alternative embodiment, the sheet material could be provided in another fashion, such as from a fanfold stack, for example.

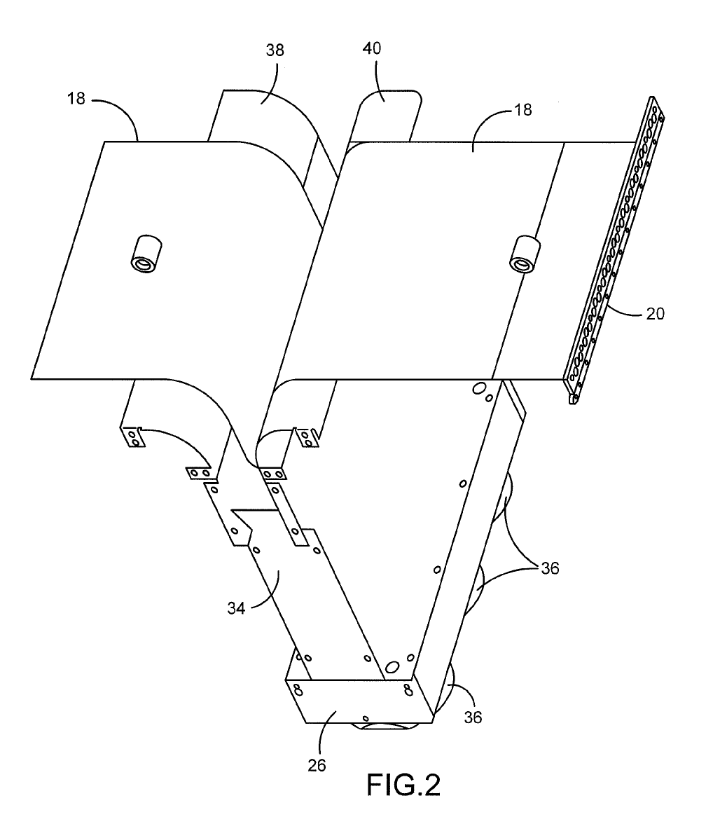

In the illustrated embodiment, the sheet material 12 comprises a substrate, such as paper, which may include information printed on the substrate. In an alternative embodiment, the apparatus could comprise a printer (not shown) between the roll 14 and the feeder 16 for printing information on the substrate. The sheet material 14 enters the feeder 16 as a continuous sheet material web 18. The feeder 16 is adapted to feed the web 18 into the cutter 20. In one embodiment, the cutter 20 comprises a guillotine cutter for cutting the web 18 into individual sheets. Other cutters may also be used. A simplified model of a pinless cutter 20 is shown in FIG. 2. The sheets are output from the cutter 20 as indicated by arrow 22 to another device, such as an accumulator, for example.

Referring also to FIGS. 2-5, the feeder 16 generally comprises a first drive 24, a vacuum box 26, a brake 28, and a second drive 30. In some embodiments, the first drive 24 operates at a constant speed. The continuous motion may enable easier unrolling of the web 18 from the roll 14. The second drive 30 stops and starts to allow the web 18 to be fed into the cutter 20, and stops the web 18 during cutting by the cutter 20. The vacuum box 26 forms an area for the web to move to accommodate varying lengths of the web (e.g., between the drives 24, 30) caused by the different motions of the first and second drives 24, 30.

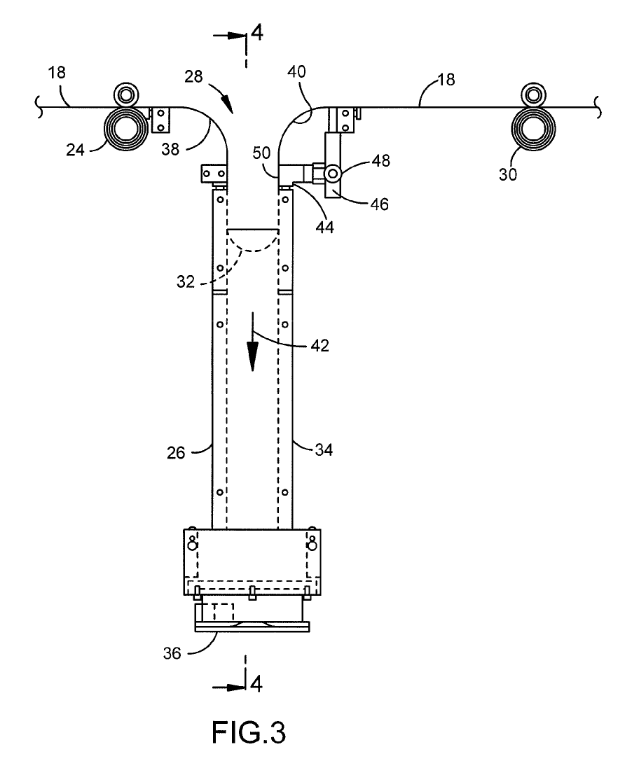

In the illustrated embodiment, the transport mechanism (e.g., feeder 16) for the cutter comprises two sets of drive nips forming the first and second drives. The vacuum box 26 is located between the drives 24, 30 to provide tension in the web 18 between the drives 24, 30. During steady state cutter operation, the upstream first drive 24 moves with relatively constant velocity feeding the web 18 into the vacuum box 26 creating a loop 32, as shown in FIG. 3. The downstream second drive 30 starts and stops every cycle, advancing that portion of the web 18 equal to the document/sheet length size to be cut.

The vacuum box 26 comprises a frame 34 containing several fans 36 at its base. The loop 32 can lengthen and shorten inside the vacuum box 26 due to the motion differential between the two drives 24, 30. The fans 36 create a low pressure zone under the loop 32 which provides web tension of the web 18 between the two drives 24, 30. The feeder 16 includes an entrance support surface or deck 38 into the vacuum box 26 for the web 18 to slide along. The feeder 16 also includes an exit support surface or deck 40 out of the vacuum box 26 for the web 18 to slide along. The two surfaces 38, 40 are curved to provide for a smooth motion of the web 18 along the surfaces 38, 40.

Rapid deceleration of the web 18 by the second drive 30, such as that encountered in a high speed cutter system, may create a peak inertia load on the web 18 that is significantly larger than the tension force provided by a vacuum box 26. For example, the peak inertia load might be 3.5 lb. and the tension force provided by the vacuum force 42 in the vacuum box may only be 0.5 lb. The vacuum force 42 cannot be increased because that may cause the web 18 to break. Intermediate changing of the vacuum force 42 will not work because the response time of the fans 36 and air pressure change inside the vacuum box 26 would likely be too slow. The brake 28 has been added to provide a fast responding supplement to the vacuum force 42 during rapid deceleration to maintain sufficient web tension on the web 18 between the brake 28 and the second drive 30. With the web 18 properly tensioned, this allows proper tracking of the web and provides an accurate sheet length cut with the high speed cutter 20.

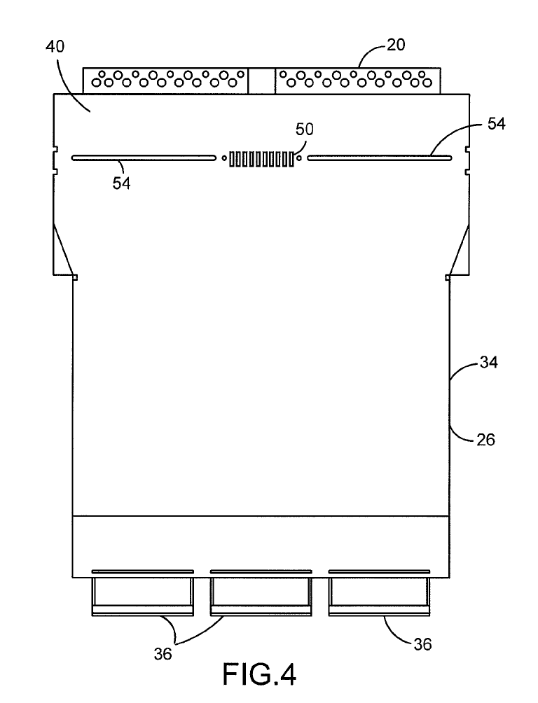

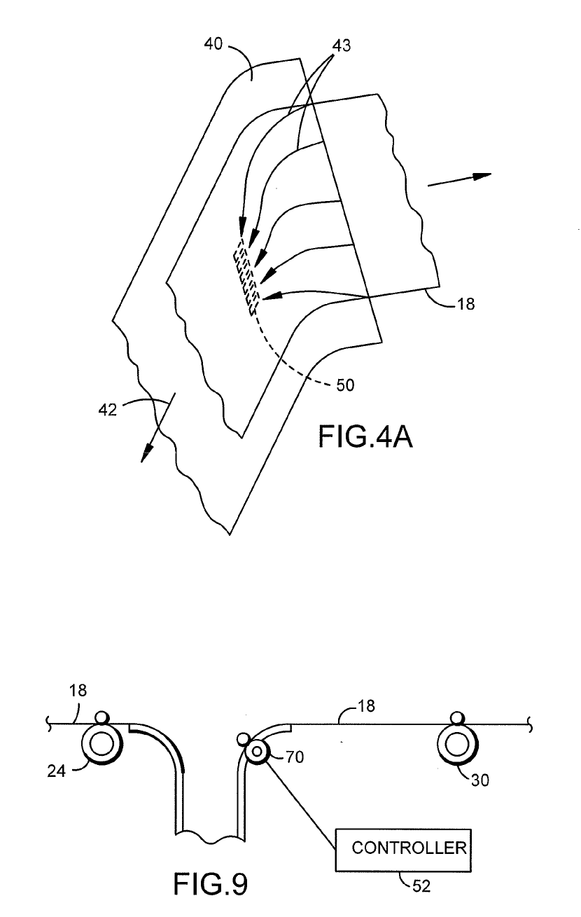

The brake 28 is located proximate to the exit from the vacuum box 26. Referring also to FIG. 6, the illustrated embodiment of the brake 28 comprises a pneumatic manifold 44, a pneumatic valve 46, and a vacuum source 48. The vacuum source may comprise, for example, a venturi vacuum generator. However, any suitable source of vacuum could be provided. Vacuum slots 50 are located in the middle of the downstream side of the frame 34 of the vacuum box 26 in close proximity to the curved deck section 40, as shown in FIGS. 3 and 4. The slots 50 form a vacuum inlet. The manifold 44 is attached to the outside of the frame at the slots 50. In this embodiment, the valve 46 is a solenoid valve that is provided integrally with the vacuum generator 48. The valve/generator 46/48 is connected to the manifold 44.

During the web advance acceleration motion, the valve 46 is closed (i.e., turned off) and is opened (i.e., turned on) just as the web 18 begins deceleration. The apparatus 10 includes a controller 52 that is adapted to actuate the valve. When the valve is turned on, the air starts passing through the venturi generator 48, which creates vacuum air flow through the slots 50, thereby acquiring and creating a retarding friction force on the web 18.

The friction force is created between the web 18 and the deck section 40. The slots 50 are provided only in the middle section of the width of the frame 34, as seen best in FIG. 4. Thus, the web brake is applied only to the middle section of the web 18. However, referring also to FIG. 4A, because the slots 50 are located upstream of the curved deck section 40, the web tension in the area between second drive 30 and the deck section 40 is uniformly distributed across the width of the web 18. The force is distributed along the length of the curved deck 40, as indicated by friction force arrows 43. This supplemental force 43 during deceleration may eliminate wrinkling of the web 18 and mis-tracking of the web 18. The two forces 42, 43 may counteract the force 45 of the web's forward inertia when the drive 30 is stopped for cutting of the web 18. Slots 54, shown best in FIG. 4, are mounting slots used to attach side guides for the web material.

In one example, the invention may be used in a pneumatic tensioning mechanism and control for a pinless cutter. In such an application, a brake is applied to the web during the deceleration portion of the motion, keeping the web under tension. Moreover, the web tension is controlled by an additional friction force applied to the web only during the deceleration part of the web advance motion.

In one example, the force generated by the brake may be amplified by the geometry of the curved deck 40 by an amount [ê(f*alpha)], where f is the coefficient of friction between the web 18 and curved deck 40, and alpha is the angle the web wraps around the guide (expressed in radians). To avoid web breaks and excessive tension, this amplified force need not be much higher than the maximum inertia force of the web, Fᵢₙ₋ₘₐₓ, experienced during deceleration.

In practice, the coefficient of friction depends on many factors, such as paper type, paper quality, amount of ink or toner on the surface of the paper, type of ink or toner, etc. For example, it is well known that the coefficient of friction of printed material can vary significantly from one type of material to another. The friction force generated by the vacuum brake and applied to the moving web can be determined by the following expression:

F=f*N=f*Svs*Pv (Eq. 1)

where:

f=the dynamic coefficient of friction between the paper and the deck

N=the normal force

Svs=the total area of the vacuum slots

Pv=pressure generated by the vacuum

alpha=the angle the web wraps around guide

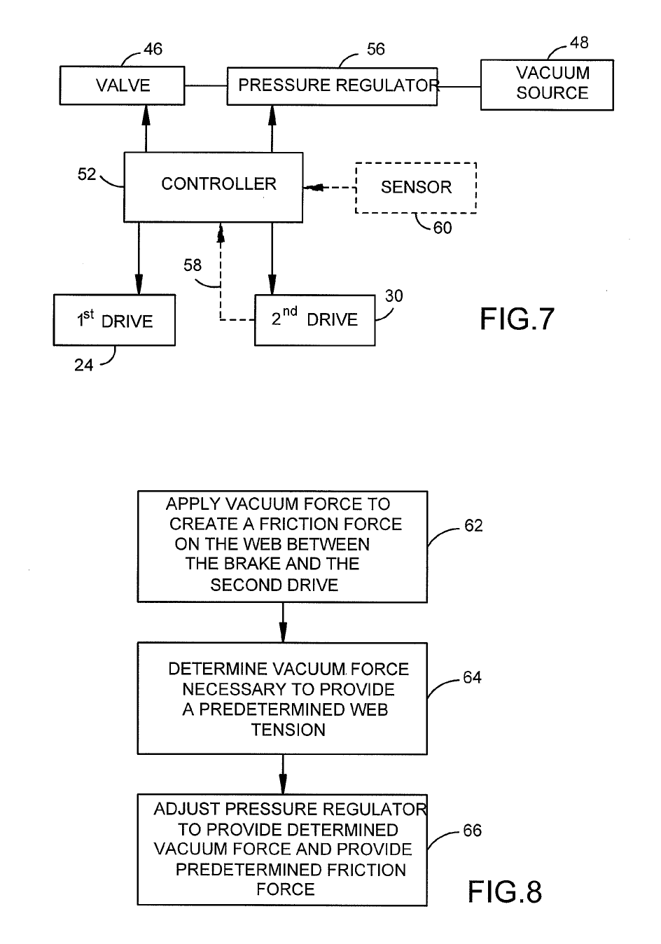

The normal force N is the vacuum force provided by the brake 28. To keep the friction force relatively constant for all paper applications, the vacuum pressure in the brake can become a function of the paper coefficient of friction on the deck. Referring also to FIG. 7, to provide automatic adjustment of the friction force generated by the brake in order to accommodate different webs having different frictional properties, a proportional air pressure regulator 56 may be introduced between the pressure source and the valve. In the illustrated embodiment, the pressure regulator 56 is connected to the controller 52. The pressure regulator 56 is adapted to increase or decrease air pressure or flow through vacuum generator. Increasing or decreasing of the air pressure or flow through vacuum generator will increase or decrease the vacuum level in the vacuum slots 50. This will proportionally change the friction force applied to the web 18 at the surface 40.

In a further example, one way to calibrate the tension force for a specific web application is to advance the web slowly at constant velocity while recording the digital-to-analog converter (DAC) value of the second drive 30. That value is proportional to the torque generated by the drive motor. The value can be communicated to the controller 52 as indicated by line 58. The acquired DAC value can next be compared against the required tension force value and the difference can be converted into the voltage or current to be applied to the pressure regulator 56. However, in alternative embodiments, any suitable method could be provided. In an alternative embodiment and method, the apparatus could have a separate sensor 60 to sense or detect web tension.

Referring also to FIG. 8, one embodiment of the method of the invention comprises applying a vacuum force to the web to create a friction force on the web between the brake and the second drive as indicated by block 62, determining a vacuum force necessary to provide a predetermined web tension as indicated by block 64, and adjusting the pressure regulator to provide the determined vacuum force and provide a predetermined friction force as indicated by block 66.

Alternative embodiments of the invention can include, for example, replacing the venturi vacuum generator with a vacuum pump. In another embodiment, the passive friction tensioning device may be replaced with a servo driven nip, which may assist in conveying the web during acceleration, but may impart a retarding force during deceleration of the web, thereby maintaining consistent tension. An example of this can be seen in FIG. 9, in which a third drive 70 is connected to the controller 52.

Embodiments of the invention provide a method and device for keeping a web under tension to achieve an accurate sheet length cut in a pinless high speed cutter. In some embodiments, a web tensioning force is provided by a vacuum box and an additional friction force is applied to the web only during the deceleration portion of the web advance motion profile using a web brake. The friction force applied by the brake may be automatically adjusted to be a function of the sheet material coefficient of friction using a proportional air pressure regulator.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A sheet material feeder, comprising:
a sheet material web;
a vacuum box applying a tension force to a portion of the sheet material web extending into the vacuum box by applying a first vacuum force on the sheet material web;
a first drive feeding the sheet material web into the vacuum box;
a second drive pulling the sheet material web out of the vacuum box; and
a system for applying a braking force to the sheet material web proximate to the vacuum box only during a decelerating movement of the sheet material web at the second drive.

2. The sheet material feeder of claim 1, wherein the braking force maintains the sheet material web in tension between the vacuum box and the second drive.

3. The sheet material feeder of claim 1, wherein the system for applying the braking force comprises a surface extending out of the vacuum box, and wherein the braking force is caused by a second vacuum force pulling the sheet material web against the surface.

4. The sheet material feeder of claim 3, wherein the surface comprises a curved surface extending out of the vacuum box.

5. The sheet material feeder of claim 3, wherein the system for applying the braking force comprises:
a vacuum inlet at the surface in fluid communication with a vacuum source;
a valve connected between the vacuum source and the vacuum inlet; and
a controller connected to the valve for selectively actuating the valve to create the second vacuum force at the vacuum inlet.

6. The sheet material feeder of claim 5, wherein the controller actuates the valve only during the decelerating movement of the sheet material web at the second drive.

7. The sheet material feeder of claim 5, wherein the vacuum inlet is provided at a middle section of a width of the surface.

8. The sheet material feeder of claim 5, wherein the system for applying the braking force further comprises a pressure regulator connected to the valve for varying the second vacuum force.

9. The sheet material feeder of claim 8, wherein the controller is connected to the pressure regulator for controlling the pressure regulator.

10. The sheet material feeder of claim 9, wherein the controller is further connected to the second drive, and wherein the system for applying the braking force further comprises a system for adjusting the vacuum force at the vacuum inlet based on a force applied to the second drive by the sheet material web.

11. The sheet material feeder of claim 2, further comprising a system for adjusting the braking force based on the tension of the sheet material web between the vacuum box and the second drive.

12. The sheet material feeder of claim 11, wherein the system for adjusting the braking force comprises:
an element for sensing the tension of the sheet material web between the vacuum box and the second drive; and
an element for adjusting the braking force based on the sensed tension.

13. The sheet material feeder of claim 12, wherein the element for sensing the tension of the sheet material web between the vacuum box and the second drive comprises the second drive.

14. The sheet material feeder of claim 12, wherein the element for adjusting the braking force based on the sensed tension comprises a pressure regulator connected to a source of vacuum.

15. An apparatus, comprising:
a sheet material feeder as in claim 1; and
a sheet material cutter downstream from the second drive for cutting the sheet material web into individual sheets.

16. A method of maintaining web tension in a sheet material feeder, comprising:
feeding a sheet material web from a first drive, through a vacuum box, to a second drive; and
applying a braking force to the sheet material web proximate to the vacuum box only during a decelerating movement of the sheet material web at the second drive, wherein the braking force supplements a vacuum force applied to the sheet material web in the vacuum box to maintain a web tension of the sheet material web between the vacuum box and the second drive.

17. The method of claim 16, further comprising adjusting the braking force based on the web tension of the sheet material web between the vacuum box and the second drive.

18. The method of claim 17, wherein adjusting the braking force comprises adjusting the braking force based on a web tension sensed by a sensor.

19. The method of claim 18, wherein the sensor comprises the second drive.

20. A method of maintaining web tension in a sheet material feeder, comprising:
feeding a sheet material web from a first drive, through a vacuum box, to a second drive;
applying a force to the sheet material web proximate to the vacuum box only during a decelerating movement of the sheet material web at the second drive to thereby form a frictional brake to maintain a web tension of the sheet material web between the vacuum box and the second drive; and
adjusting the force based on a coefficient of friction of the sheet material web to provide a substantially uniform friction force for sheet material webs comprising different compositions of materials.
